(19) United States
(12) Patent Application Publication
(10) Pub. No.: US 2010/0045655 A1
(43) Pub. Date: Feb. 25, 2010

(54) DISPLAY

(76) Inventor: Byung-Tak Jang, Seongnam-si (KR)

Correspondence Address: SHERR & VAUGHN, PLLC, 620 HERNDON PARKWAY, SUITE 320, HERNDON, VA, 20170, US

(21) Appl. No.: 12/537,193

(22) Filed: Aug. 6, 2009

(30) Foreign Application Priority Data
Aug. 25, 2008 (KR) 10-2008-0082763

(51) Int. Cl. G09G 5/00

(52) U.S. Cl. 345/213

(57) ABSTRACT

A display is provided, which includes a timing controller, a data driver, and first and second termination resistors. The timing controller transmits a transmission signal, including at least one of a data signal, a clock signal, and a strobe signal, in a differential format and drives current in a pull mode. The data driver reconstructs the data from the transmission signal. One end of each of the first and second termination resistors is connected respectively between the data driver and terminations of first and second transmission signal lines, each signal line being a path through which the transmission signal is transmitted from the timing controller to the data driver and the other ends thereof are connected respectively to first and second termination voltage sources. Thus, it is possible to more simply implement the timing controller on the transmitting side, and also to increase data transmission efficiency.

The present application claims priority under 35 U.S.C. 119 to Korean Patent Application No. 10-2008-0082763 (filed on 25 Aug. 2008), which is hereby incorporated by reference in its entirety.

### BACKGROUND

The market for digital household electrical appliances and personal computers is constantly on the rise, along with the increased spread of portable electronic devices such as notebook computers and personal portable communication devices. Displays, which are the final connection media between such devices and users, require technology for small weight and low-power consumption. Recently, users have trended towards using flat panel displays (hereinafter referred to as “displays”), such as Liquid Crystal Displays (LCDs), Plasma Display Panels (PDPs), or Organic Electro-Luminescence Displays (OELDs), rather than conventional Cathode Ray Tubes (CRTs).

Currently, displays generally require a timing controller, a scan driver, and a data driver to drive a panel that is actually used for display. However, such displays cause considerable ElectroMagnetic Interference (EMI), Radio Frequency Interference (RFI), or the like in the wiring that carries data signals between the timing controller and the data driver, which is also called a source driver.

Currently, displays are constantly being improved to achieve a large screen and a high resolution. High-resolution panels require high-speed transmission of data to inputs of data drivers that drive data lines since the high-resolution panels include hundreds to thousands of data lines.

Since requirements for EMI or the like are becoming more stringent, and the need for technologies which transmit signals at a high speed is increasing, small-signal differential signaling schemes such as Reduced Swing Differential Signaling (RSDS) and mini-LVDS may be used in an intra-panel interface that connects the timing controller and the data driver. Recently, attempts have been made here and overseas to implement an intra-panel interface on a point-to-point basis. FIG. 1 illustrates an example of a display that employs a point-to-point intra-panel interface.

As shown in FIG. 1, the display includes a timing controller 14, data drivers 24, scan drivers 30, and a display panel 40. The display panel 40 is a portion for displaying an image according to scan signals S₁ to Sₙ and data signals D₁ to Dₘ. The display panel 40 may be any of a variety of display panels including an LCD panel, a PDP panel, or an OLED panel. The scan drivers 30 apply scan signals S₁ to Sₙ to the display panel 40 and the data drivers 24 apply data signals D1 to Dm to the display panel 40. The timing controller 14 provides data signals DT to the data drivers 24 and applies clock signals CLK and CLK_R to the data drivers 24 and the scan drivers 30, respectively. Each data signal DT provided from the timing controller 14 to each data driver 24 may include only image data for display on the display panel 40 or may also include both image data and a control signal. The timing controller 14 may provide the data signal DT to each data driver 24 using a single-ended signaling scheme which uses a single wiring or using a differential signaling scheme which uses two transmission signal lines such as a Low Voltage Differential Signaling (LVDS) scheme.

FIG. 2 illustrates an example of the timing controller 14 that can be used in the display of FIG. 1. As shown in FIG. 2, the timing controller 14 includes a receiving unit 51, a buffer memory 52, a timing control circuit 53, and a transmitting unit 54. The receiving unit 51 functions to receive the transmission data. The receiving unit 51 may also receive a transmission control signal. More specifically, the receiving unit 51 functions to convert an image data signal and a received control signal input to the timing controller 14 into a Transistor-Transistor Logic (TTL) signal. The received signal input to the timing controller 14 may be an LVDS-format signal, a Transition Minimized Differential Signaling (TMDS)-format signal, or a signal of another format. The buffer memory 52 temporarily stores, and then outputs the data.

The timing control circuit 53 receives the TTL signal, into which the received control signal has been converted, and generates a clock signal CLK_R to be provided to each scan driver 30, and a clock signal CLK to be provided to each data driver 24. The transmitting unit 54 receives data output from the buffer memory 52 and outputs a plurality of transmission signals to be provided to the plurality of data drivers 24. Each transmission signal includes a serialized data signal. The transmitting unit 54 includes a demultiplexer 55, a plurality of serializers 56, and a plurality of drivers 57. The demultiplexer 55 divides image data output from the buffer memory 52 into sections corresponding to the data drivers 24 and provides the data sections to the serializers 56, respectively. Each of the serializers 56 serializes data received from the demultiplexer 55 and outputs the serialized data. Each of the drivers 57 functions to generate a data signal DT having a level corresponding to serialized data received from a corresponding serializer 56. That is, each of the drivers 57 converts received serialized data into an analog signal and outputs the analog signal. The signal output from each driver 57 may be a differential signaling format signal such as an LVDS signal or may be a single-ended signaling format signal.

FIG. 3 illustrates an example of a data driver 24 that can be used in the display of FIG. 1. As shown in FIG. 3, the data driver 24 includes a receiving unit 61, a shift register 62, a data latch 63, and a Digital-to-Analog Converter (DAC) 64. The receiving unit 61 samples a data signal DT included in a received signal according to the received clock signal CLK and reconstructs a control signal such as data and a Start Pulse (SP) according to a predefined protocol. The receiving unit 61 includes a reference voltage generator 65, a multilevel detector 66, and a sampler 67. The reference voltage generator 65 generates a reference voltage. The multilevel detector 66 determines a range to which the level of the data signal DT belongs using reference voltages output from the reference voltage generator 65 and outputs the determination. The sampler 67 functions to sample and output a signal output from the multilevel detector 66 using the received clock signal CLK. The shift register 62 functions to sequentially shift and then output the Start Pulse (SP). The data latch 63 functions to sequentially store data output from the receiving unit 61 according to a signal output from the shift register 62 and then to output the data in parallel. The DAC 64 converts a digital signal output from the data latch 63 into an analog signal and outputs the analog signal.

FIG. 4 schematically illustrates the interface circuit portion between the timing controller 14 and the data drivers 24 shown in FIG. 1. A circuit 70 shown in FIG. 4 is provided at the output side of each driver 57 in the timing controller 14, and a circuit 94 corresponds to the data driver 24 and a receiving unit 96 corresponds to the receiving unit 61.

The circuit 70 includes a constant current source 72, a dependent current source 74, switches 76 and 78, a common-mode voltage adjustor 80. The common-mode voltage adjustor 80 includes an operational amplifier 82 and resistors R1 and R2.

As shown in FIG. 4, the timing controller 14 drives current in a push-pull mode and transmits a differential transmission signal. Termination resistors or impedance matching resistors R_{TERM}, whose resistance is twice as high as the characteristic impedance of transmission signal lines 90 and 92, are provided at terminations of the transmission signal lines 90 and 92 such that the resistors R_{TERM} are externally adjacent to the data driver chip 94. Even though the termination resistors of the transmission signal lines 90 and 92 having the same impedance as the characteristic impedance of the transmission signal lines 90 and 92 are not connected to the common-mode voltage, it is possible to achieve the same effects as if they did since the transmission signal lines 90 and 92 are driven by voltages having the same magnitude and opposite polarities to each other on the basis of the common-mode voltage.

FIG. 5 illustrates waveforms of signals received by the data driver 94 shown in FIG. 4. The operation of a display having the configuration detailed above is described as follows with reference to FIG. 5. When the constant current source 72 is connected to the second transmission signal line 92 and the dependent current source 74 is connected to the first transmission signal line 90 through switching operations of the switches 76 and 78, a signal PCH received by the data driver 94 switches to a low level 86 and a signal NCH received by the data driver 94 switches to a high level 84. On the other hand, when the constant current source 72 is connected to the first transmission signal line 90 and the dependent current source 74 is connected to the second transmission signal line 92 through switching operations of the switches 76 and 78, a signal PCH received by the data driver 94 switches to a high level 87 and a signal NCH received by the data driver 94 switches to a low level 88.

In this interface, a termination resistor R_{TERM} should be provided just before the data driver 94, with one transmission signal line 90 or 92 being shared by a number of data drivers 57 in parallel. That is, the termination resistors R_{TERM} are not provided inside the data driver 94. However, there is a possibility that termination resistors R_{TERM} may be provided inside the data driver 94 in a one-to-one (i.e., point-to-point) transmission scheme. When differential driving is performed, termination resistors R_{TERM} can be connected to each other rather than to termination voltage sources V_{TERM}. In this case, the transmitting end 70 must function to maintain a common-mode voltage to allow the transmission signal lines 90 and 92 to be driven symmetrically on the basis of the common-mode voltage. That is, there is a problem in that the transmitting end 70 needs to include a common-mode voltage adjustor 80, as a feedback loop, that receives a common-mode voltage, compares it with an internally generated reference voltage V_{ref} and controls the dependent current source 74 so that the common-mode voltage is always maintained.

In addition, since the output side 70 of the timing controller 14 drives current in a push-pull mode, the circuit configuration is complicated and, while current is driven alternately in push and pull modes, a time difference may occur between the push and pull mode driving procedures, resulting in fluctuation of the common-mode voltage. Thus, the time difference should be taken into consideration when designing the timing controller.

### SUMMARY

Embodiments relate to signal processing, and more particularly, to a display that includes a source driver for a Chip On Glass (COG), a Chip On Film (COF), or a Tape Carrier Package (TCP) and a timing controller that transmits data and a control signal to the source driver.

Embodiments relate to a display that simplifies implementation of a timing controller, which is on the transmitting side of a transmission system suitable for one-to-one (i.e., point-to-point) data transmission and receiving, and simplifies required components outside the chip of a data driver which is a receiving side of the transmission system.

Embodiments relate to a display which includes a timing controller that transmits a transmission signal, including at least one of a data signal, a clock signal, and a strobe signal, in a differential format and that drives current in a pull mode, a data driver that reconstructs the data from the transmission signal, and first and second termination resistors, one end of each of the first and second termination resistors being connected respectively between the data driver and terminations of first and second transmission signal lines, each being a path through which the transmission signal is transmitted from the timing controller to the data driver, and the other ends of the first and second termination resistors being connected respectively to first and second termination voltage sources.

Embodiments relate to a display which includes a timing controller that transmits a transmission signal, including at least one of a data signal, a clock signal, and a strobe signal, in a differential format and that drives current in a push mode, a data driver that reconstructs the data from the transmission signal, and first and second termination resistors, one end of each of the first and second termination resistors being connected respectively between the data driver and terminations of first and second transmission signal lines, each being a path through which the transmission signal is transmitted from the timing controller to the data driver.

### DRAWINGS

FIG. 1 illustrates an example of a display that employs a point-to-point intra-panel interface.

FIG. 2 illustrates an example of a timing controller that can be used in the display of FIG. 1.

FIG. 3 illustrates an example of a data driver that can be used in the display of FIG. 1.

FIG. 4 schematically illustrates an interface circuit portion between the timing controller and the data drivers shown in FIG. 1.

FIG. 5 illustrates waveforms of signals received by the data driver shown in FIG. 4.

Example FIG. 6 is a schematic diagram of a display according to embodiments.

Example FIG. 7 illustrates waveforms of transmission signals received by a data driver shown in example FIG. 6.

Example FIG. 8 is a schematic diagram of a display according to embodiments.

Example FIG. 9 illustrates waveforms of transmission signals received by the data driver shown in example FIG. 8.

Example FIG. 10 is a schematic diagram of a display according to embodiments.

Example FIG. 11 illustrates waveforms of signals received by the data driver shown in example FIG. 10.

Example FIG. 12 is a schematic diagram of a display according to embodiments.

Example FIG. 13 illustrates waveforms of signals received by the data driver shown in example FIG. 12.

### DESCRIPTION

Example FIG. 6 is a schematic diagram of a display according to embodiments. As shown in example FIG. 6, the display includes a timing controller 100, first and second transmission signal lines 200 and 202, and a data driver 300.

The timing controller 100 transmits a transmission signal, including at least one of a data signal, a clock signal, and a strobe signal, in a differential format. Here, the timing controller 100 drives the current in a pull mode. To accomplish this, the timing controller 100 may include a first constant current source 112 and a first switch 110.

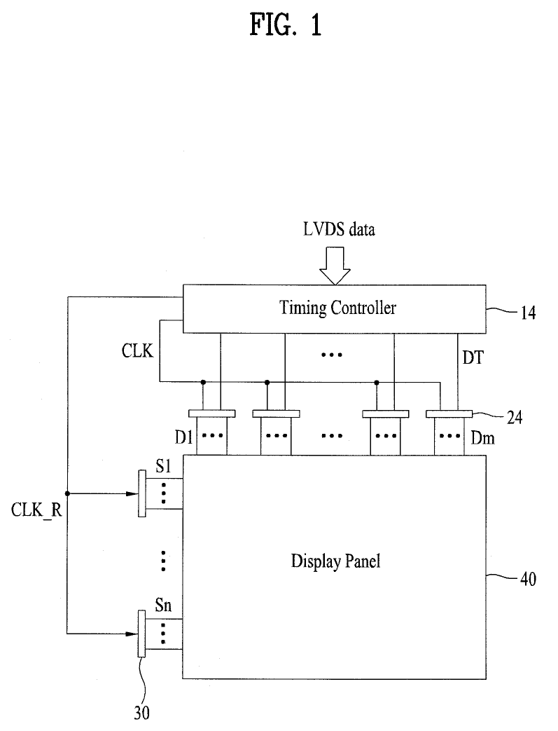

The first constant current source 112 generates a first constant current ID that flows toward a reference potential. The first switch 110 is switched in response to a selection signal S to selectively connect one of the first and second transmission signal lines 200 and 202 to the first constant current source 112. The selection signal S is generated according to the level of a transmission signal to be transmitted to the data driver 300. For example, the selection signal S may be generated according to the level of a transmission signal to be transmitted from the timing controller 14 shown in FIG. 1 to the data driver 24.

The data driver 300 receives the transmission signal and reconstructs data from the received transmission signal. To accomplish this, the data driver 300 may include a receiving unit 302. The transmission signal is transmitted from the timing controller 100 to the data driver 300 through the first and second transmission signal lines 200 and 202.

The display according to embodiments has first and second termination resistors R_{TERM1} and R_{TERM2}. One end of each of the first and second termination resistors R_{TERM1} and R_{TERM2} is connected between respective terminations (i.e., terminal ends) of the first and second transmission signal lines 200 and 202 and the receiving unit 302 of the data driver 300. The other ends of the first and second termination resistors R_{TERM1} and R_{TERM2} are connected respectively to first and second termination voltage sources V_{TERM1} and V_{TERM2}.

In the following description, it is assumed that the resistances R_{TERM} of the first and second termination resistors R_{TERM1} and R_{TERM2} are equal and the voltages V_{TERM} of the first and second termination voltage sources V_{TERM1} and V_{TERM2} are equal. For example, the resistances of the first and second termination resistors R_{TERM1} and R_{TERM2} may each be 50Ω. However, embodiments are not limited to this assumption.

Generally, the transmission signal has differential components, and the higher one of the differential components is a positive-level component and the lower one thereof is a negative-level component. When the differential signal is transmitted, the positive-level component is transmitted through one of the two transmission signal lines 200 and 202 that are used as channels for the differential signal transmission. The negative-level component is transmitted through the other transmission line. Generally, when data for transmission is a high-level signal, one of the two lines for transmission of positive-level signals is referred to as a “P-channel” and the other line for transmission of negative-level signals is referred to as an “N-channel”. However, when data for transmission is a low level signal, one of the two lines for transmission of positive-level signals is referred to as an “N-channel” and the other line for transmission of negative-level signals is referred to as a “P-channel”. In the following description, a transmission signal received through the first transmission signal line 200 is referred to as a “PCH” and a transmission signal received through the second transmission signal line 202 is referred to as an “NCH”.

Example FIG. 7 illustrates waveforms of transmission signals received by the data driver 300 shown in example FIG. 6. The operation of the display configured as described with reference to example FIG. 6 is described as follows with reference to example FIG. 7.

When the first constant current source 112 is connected to the first transmission signal line 200 by the first switch 110, a transmission signal PCH received by the data driver 300 switches to a low level 400 and a transmission signal NCH received by the data driver 300 switches to a high level 404. On the other hand, when the first constant current source 112 is connected to the second transmission signal line 202 by the first switch 110, a transmission signal PCH received by the data driver 300 switches to a high level 402 and a transmission signal NCH received by the data driver 300 switches to a low level 406.

Example FIG. 8 is a schematic diagram of a display according to embodiments. As shown in example FIG. 8, the display includes a timing controller 120, first and second transmission signal lines 200 and 202, and a data driver 310.

The circuit configuration of the display shown in example FIG. 8 is identical to that of the display shown in example FIG. 6, except that the timing controller 120 further includes a second constant current source 126 and a second switch 122. Accordingly, a receiving unit 312 corresponds to the receiving unit 302. The following description will be given only of portions different from those of the circuitry of example FIG. 6.

A second constant current source 126 generates a second constant current ID2 that flows toward the reference potential. A second switch 122 is switched in response to the level of a selection signal S1 to selectively connect one of the first and second transmission signal lines 200 and 202 to the second constant current source 126.

Example FIG. 9 illustrates waveforms of transmission signals received by the data driver 310 shown in example FIG. 8. The operation of the display configured as described above with reference to example FIG. 8 is described as follows with reference to example FIG. 9. Here, the first constant current source 112 drives current greater than that of the second constant current source 126. That is, ID>ID2.

If the second constant current source 126 is connected to the second transmission signal line 202 by the second switch 122 when the first constant current source 112 is connected to the first transmission signal line 200 by the first switch 110, a transmission signal PCH received by the data driver 310 switches to a low level 502 and a transmission signal NCH received by the data driver 310 switches to a high level 500. On the other hand, if the second constant current source 126 is connected to the first transmission signal line 200 by the second switch 122 when the first constant current source 112 is connected to the first transmission signal line 200 by the first switch 110, a transmission signal PCH received by the data driver 310 switches to a lower level 514 and a transmission signal NCH received by the data driver 310 switches to a higher level 512.

In addition, if the second constant current source 126 is connected to the first transmission signal line 200 by the second switch 122 when the first constant current source 112 is connected to the second transmission signal line 202 by the first switch 110, a transmission signal PCH received by the data driver 310 switches to a high level 508 and a transmission signal NCH received by the data driver 310 switches to a low level 510. On the other hand, if both the constant current sources 112 and 126 are connected to the second transmission signal line 202 through switching operations of the first and second switches 110 and 122, a transmission signal PCH received by the data driver 310 switches to a higher level 504 and a transmission signal NCH received by the data driver 310 switches to a lower level 506.

The display shown in example FIG. 8 is suitable for transmission of a multi-level transmission signal since the display further includes the second constant current source 126 and the second switch 122. Here, when a signal is transmitted in multiple levels, the amount of data transmitted per unit time can be increased to increase transmission efficiency. A strobe signal can also be carried in the multiple levels. In this case, the data driver 310 identifies a portion, in which the level difference between the PCH and NCH is great, as a strobe signal. Here, the strobe is a special indicator used to discriminate a data set (which is generally referred to as a “packet”) created according to a transport protocol from other data sets and is generally referred to as a “delimiter”. As one important element of the protocol, the strobe signal is a means for transmitting information about transmission data (i.e., information for transmission).

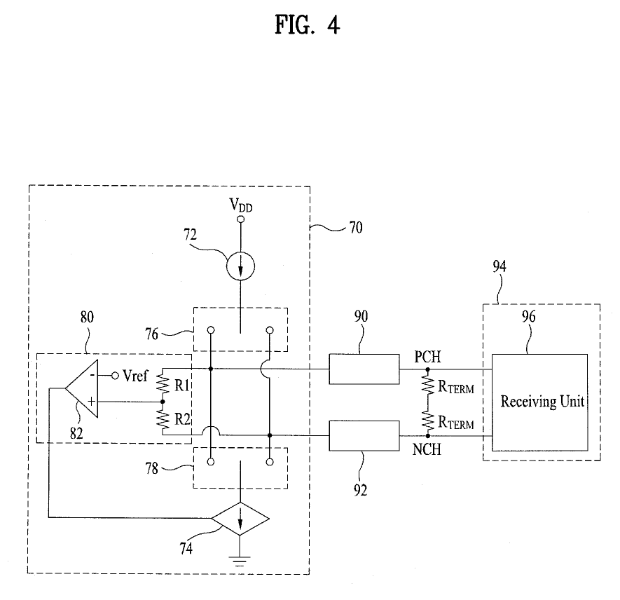

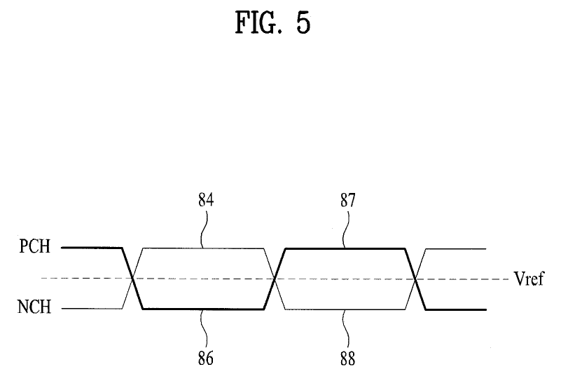

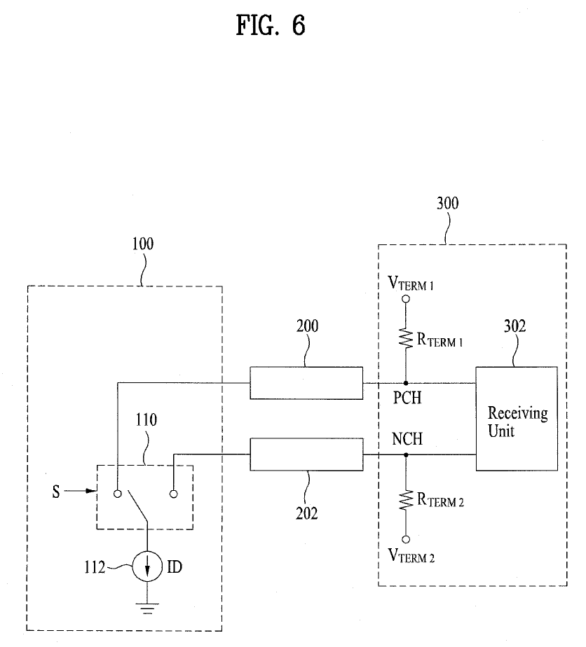

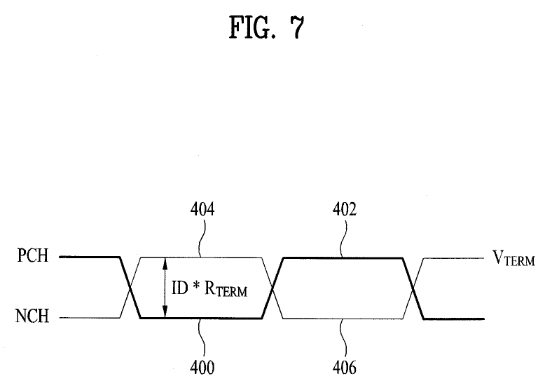

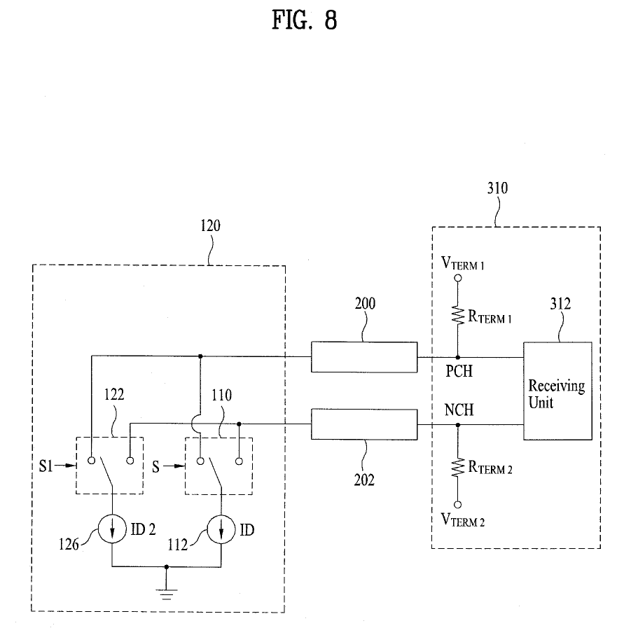

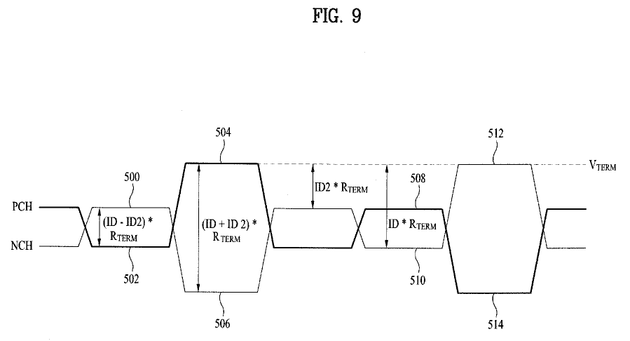

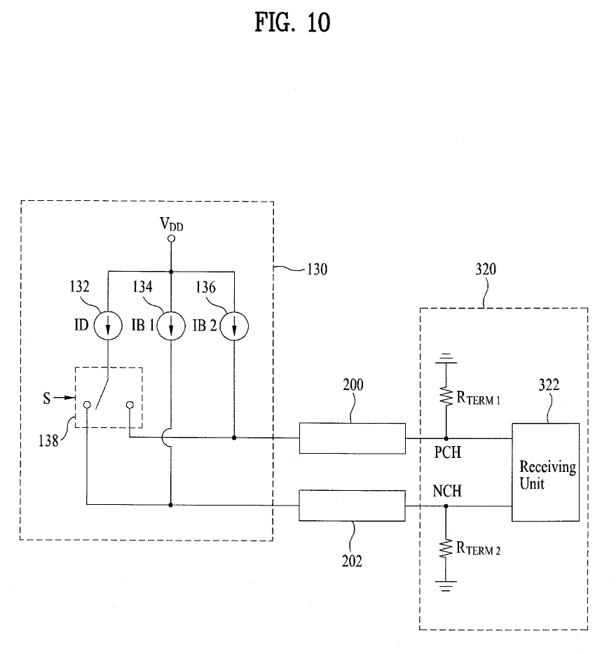

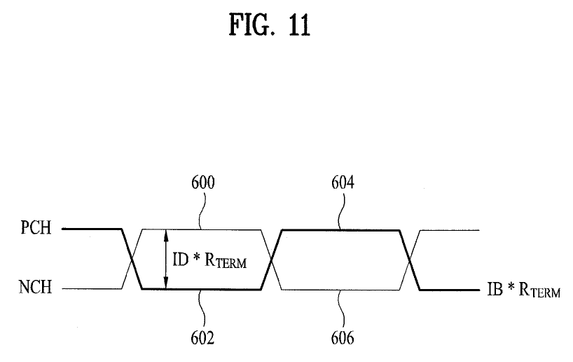

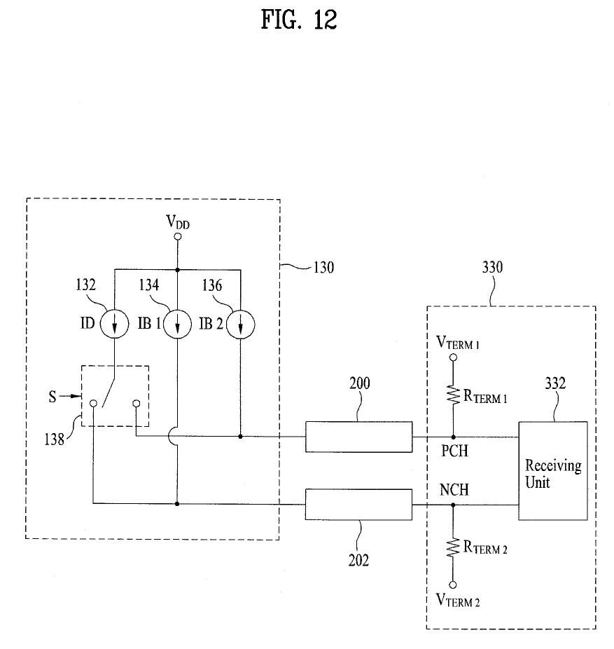

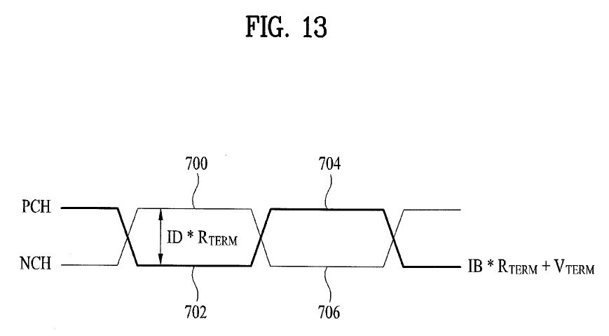

The display according to embodiments shown in example FIGS. 6 and 8 can more easily implement the timing controller 100 or 120 and also does not require the circuit 80 as shown in FIG. 4 for maintaining the common-mode voltage since the timing controller 100 or 120 drives current in a pull mode rather than in a push-pull mode, unlike the general display shown in FIG. 4. Especially, there is no constraint that driving be performed by a differential signal since the termination resistors R_{TERM1} and R_{TERM2} are connected to the termination voltage sources V_{TERM1} and V_{TERM2}. Therefore, even when an asymmetric signal is transmitted as a transmission signal, other adjacent transmission signal lines are not affected.

Example FIG. 10 is a schematic diagram of a display according to embodiments. The display includes a timing controller 130, first and second transmission signal lines 200 and 202, and a data driver 320. The timing controller 130 transmits a transmission signal, including at least one of a data signal, a clock signal, and a strobe signal, in a differential format. Here, the timing controller 130 drives current in a push mode. To accomplish this, the timing controller 130 may include a first constant current source 132 and a first switch 138 and may further include first and second bias current sources 134 and 136.

The first constant current source 132 is connected to a supply voltage V_{DD} and supplies a constant current ID to the first or second transmission signal line 200 or 202. The first switch 138 is switched in response to a selection signal S to selectively connect the first constant current source 132 to one of the first and second transmission signal lines 200 and 202. The first and second bias current sources 134 and 136 are connected to the supply voltage V_{DD} to supply first and second bias currents IB1 and IB2 respectively to the first and second transmission signal lines 200 and 202. In the following description, it is assumed that the current values IB of the first bias current IB1 and the second bias current IB2 are equal but embodiments are not limited to this assumption.

The data driver 320 receives the transmission signal and reconstructs data from the received transmission signal. The receiving unit 322 performs the same function as that of the receiving unit 302.

Similar to the display shown in example FIG. 6 or example FIG. 8, the display shown in example FIG. 10 has first and second termination resistors R_{TERM1} and R_{TERM2}. One end of each of the first and second termination resistors R_{TERM1} and R_{TERM2} are connected respectively between terminations of the first and second transmission signal lines 200 and 202 and the receiving unit 322 of the data driver 320. The other ends of the first and second termination resistors R_{TERM1} and R_{TERM2} are connected to the reference potential.

Since the reference potential, instead of the first and second termination voltages V_{TERM1} and V_{TERM2}, is connected to the termination resistors R_{TERM1} and R_{TERM2}, the display shown in example FIG. 10 does not need to generate the termination voltages V_{TERM1} and V_{TERM2}. This enables an easier design on the receiving side.

Example FIG. 11 illustrates waveforms of signals received by the data driver 320 shown in example FIG. 10. The operation of the display configured as described above with reference to example FIG. 10 is described as follows with reference to example FIG. 11. When the first constant current source 132 is connected to the second transmission signal line 202 by the first switch 138, a transmission signal PCH received by the data driver 320 switches to a low level 602 and a transmission signal NCH received by the data driver 320 switches to a high level 600. On the other hand, when the first constant current source 132 is connected to the first transmission signal line 200 by the first switch 138, a transmission signal PCH received by the data driver 320 switches to a high level 604 and a transmission signal NCH received by the data driver 320 switches to a low level 606.

As can be seen from the above description, in the case of the display shown in example FIG. 10, it is possible to adjust the common-mode voltage of the differential transmission signal by adjusting the level of the first and second bias currents IB.

Example FIG. 12 is a schematic diagram of a display according to embodiments. As shown in example FIG. 12, the display includes a timing controller 130, first and second transmission signal lines 200 and 202, and a data driver 330. The display shown in example FIG. 12 has the same configuration as the display shown in example FIG. 10, except the other ends of the first and second termination resistors R_{TERM1} and R_{TERM2} are connected respectively to the first and second termination voltage sources V_{TERM1} and V_{TERM2} rather than to the reference potential. Here, a detailed description of the same portions as those of example FIG. 10 is omitted.

Example FIG. 13 illustrates waveforms of signals received by the data driver 330 shown in example FIG. 12. The operation of the display configured as described above is described as follows with reference to example FIG. 13. When the first constant current source 132 is connected to the second transmission signal line 202 by the first switch 138, a transmission signal PCH received by the data driver 330 switches to a low level 702 and a transmission signal NCH received by the data driver 330 switches to a high level 700. On the other hand, when the first constant current source 132 is connected to the first transmission signal line 200 by the first switch 138, a transmission signal PCH received by the data driver 330 switches to a high level 704 and a transmission signal NCH received by the data driver 330 switches to a low level 706.

The display shown in example FIG. 12 operates in the same manner as the display shown in example FIG. 10, except that the low level of the transmission signal PCH or NCH is IB*R_{TERM}+V_{TERM} in the display shown in example FIG. 12 whereas the low level of the transmission signal PCH or NCH is IB*R_{TERM} in the display shown in example FIG. 10.

As shown in example FIG. 6, example FIG. 8, example FIG. 10, or example FIG. 12, both the first and second termination resistors R_{TERM1} and R_{TERM2} may be included in the data driver chip 300, 310, 320, or 330. That is, unlike the general display shown in FIG. 4, termination resistors R_{TERM} provided outside the chip 40 are provided in the chip 300, 310, 320, or 330 in embodiments. Providing the first and second termination resistors R_{TERM1} and R_{TERM2} inside the chip of the data driver 300, 310, 320, or 330 is an easy design and an increase in the area of the chip 300, 310, 320, or 330 due to addition of the resistors R_{TERM1} and R_{TERM2} is negligible. However, unlike those shown in example FIG. 6, example FIG. 8, example FIG. 10, or example FIG. 12, the first and second termination resistors R_{TERM1} and R_{TERM2} may be provided outside the data driver 300, 310, 320, or 330. However, providing the resistors R_{TERM1} and R_{TERM2} inside the chip 300, 310, 320, or 330 makes the circuit configuration simpler, from the viewpoint of circuit applications, than providing them outside the chip.

Although both the first and second termination voltage sources V_{TERM1} and V_{TERM2} may be included inside the data driver 300, 310, or 330 as shown in example FIG. 6, example FIG. 8, or example FIG. 12, the first and second termination voltage sources V_{TERM1} and V_{TERM2} may also be provided outside the data driver 300, 310, or 330 unlike those shown in example FIG. 6, example FIG. 8, or example FIG. 12.

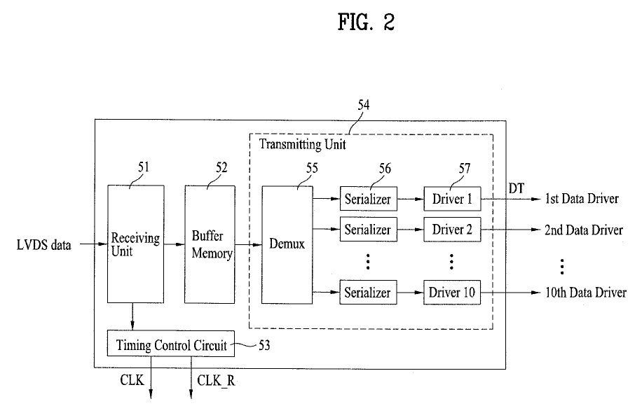

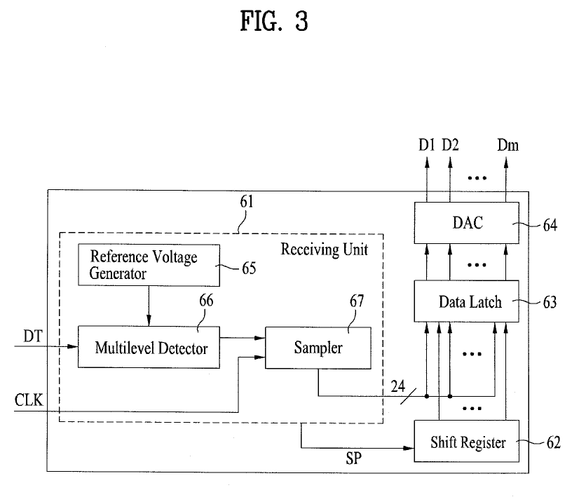

The circuitry of the display according to embodiments described above, instead of the interface circuit portion of FIG. 4, can be applied to the display shown in FIGS. 1 to 3. That is, the circuit portion 100, 120, or 130 in the display circuitry according to embodiments may be provided at the output terminal of each driver 57 shown in FIG. 2, the receiving unit 302, 312, 322, or 332 may correspond to the receiving unit 61 shown in FIG. 3, the circuit between the receiving unit 302, 312, 322, or 332 and the first and second transmission signal lines 200 and 202 may be provided, respectively, between the DT and the receiving unit 61 and between the CLK and the receiving unit 61 shown in FIG. 3. However, the configuration of the display according to embodiments shown in example FIGS. 6 to 13 is not limited to that shown in FIGS. 1 to 3.

As is apparent from the above description, the display according to embodiments has a variety of advantages. For example, since the timing controller does not drive current in a push-pull mode but instead drives current either in a push mode or in a pull mode, there is no problem described above that may occur when current is driven in a push-pull mode. In other words, there is no possibility that a time difference will occur between the push and pull mode driving procedures thereby resulting in fluctuation of the common-mode voltage. This removes the need to take into consideration the driving time difference between switches when designing the timing controller and thus the timing controller only needs to drive current either in a push mode or in a pull mode, so that it is possible to more easily implement the timing controller. Unlike the related timing controller, the timing controller of embodiments does not require a circuit for maintaining the common-mode voltage. The timing controller can also transmit a transmission signal in a multilevel format, thereby increasing data transmission efficiency. In addition, it is possible to simplify circuit implementation of the receiving side since the data driver that receives the transmission signal does not need to generate termination voltages.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a timing controller that transmits a transmission signal, including at least one of a data signal, a clock signal, and a strobe signal, in a differential format and that drives current in a pull mode;
a data driver that reconstructs the data from the transmission signal; and
first and second termination resistors, each resistor having two ends, one end of the first and second termination resistors being connected respectively between the data driver and terminations of first and second transmission signal lines, each signal line being a path through which the transmission signal is transmitted from the timing controller to the data driver, and the other ends of the first and second termination resistors being connected respectively to first and second termination voltage sources.

2. The apparatus of claim 1, wherein the timing controller includes:
a first constant current source that generates a first constant current that flows toward a reference potential.

3. The apparatus of claim 2, wherein the timing controller includes a first switch that is switched in response to a level of the transmission signal to selectively connect one of the first and second transmission signal lines to the first constant current source.

4. The apparatus of claim 3, wherein the timing controller further includes a second constant current source that generates a second constant current that flows toward the reference potential.

5. The apparatus of claim 4, wherein the timing controller further includes a second switch that is switched in response to the level of the transmission signal to selectively connect one of the first and second transmission signal lines to the second constant current source.

6. The apparatus of claim 5, wherein the transmission signal is a multi-level transmission signal.

7. The apparatus of claim 1, wherein the first and second termination resistors are included in the data driver.

8. The apparatus of claim 1, wherein the first and second termination voltage sources are included in the data driver.

9. The apparatus of claim 1, wherein resistances of the first and second termination resistors are equal.

10. The apparatus of claim 1, wherein voltages of the first and second termination voltage sources are equal.

11. An apparatus comprising:
a timing controller that transmits a transmission signal, including at least one of a data signal, a clock signal, and a strobe signal, in a differential format and that drives current in a push mode;
a data driver that reconstructs the data from the transmission signal; and
first and second termination resistors, each resistor having two ends, one end of each of the first and second termination resistors being connected respectively between the data driver and terminations of first and second transmission signal lines, each signal line being a path through which the transmission signal is transmitted from the timing controller to the data driver.

12. The apparatus of claim 11, wherein the timing controller includes:
a first constant current source that is connected to a supply voltage and supplies a constant current to the first or second transmission signal line; and
a first switch that is switched in response to a level of the transmission signal to selectively connect the first constant current source to one of the first and second transmission signal lines.

13. The apparatus of claim 12, wherein the timing controller further includes:
first and second bias current sources that are connected to the supply voltage and supply first and second bias currents to the first and second transmission signal lines, respectively.

14. The apparatus of claim 13, wherein the other ends of the first and second termination resistors are connected respectively to first and second termination voltage sources.

15. The apparatus of claim 13, wherein each of the other ends of the first and second termination resistors is connected to a reference potential.

16. The apparatus of claim 11, wherein resistances of the first and second termination resistors are equal.

17. The apparatus of claim 12, wherein voltages of the first and second termination voltage sources are equal.

18. The apparatus of claim 11, wherein the first and second termination resistors are included in the data driver.

19. The apparatus of claim 18, wherein the first and second termination voltage sources are included in the data driver.

20. The apparatus of claim 13, wherein levels of the first and second bias currents are adjusted to adjust a common-mode voltage of the transmission signal in the differential format.
